(19) United States
(12) Patent Application Publication
(10) Pub. No.: US 2022/0413277 A1
(43) Pub. Date: Dec. 29, 2022

(54) LASER CAPTURE MICRODISSECTION APPARATUS, SYSTEM AND METHOD

(71) Applicant: Fluidigm Corporation, South San Francisco, CA (US)

(72) Inventors: Daaf Sandkuijl, South San Francisco, CA (US); Alan Carpino, South San Francisco, CA (US)

(73) Assignee: Fluidigm Corporation, South San Francisco, CA (US)

(21) Appl. No.: 17/777,894

(22) PCT Filed: Nov. 17, 2020
(86) PCT No.: PCT/US2020/060892

§ 371 Date: May 18, 2022

Related U.S. Application Data
(60) Provisional application No. 62/937,624, filed on Nov. 19, 2019.

(51) Int. Cl. G02B 21/16; G02B 21/32

(52) U.S. Cl. CPC G02B 21/16; G02B 21/32; G01N 2001/2886

(57) ABSTRACT

A microscopy apparatus comprises a microscope comprising a stage configured to hold a tissue sample, a UV laser assembly configured to emit a UV laser beam to a viewing area of the tissue sample, and an IR laser assembly configured to emit an IR laser beam to the viewing area of the tissue sample. The UV and IR laser assemblies are oriented so as to emit the respective UV and IR laser beams in a same direction.

### CROSS-REFERENCE TO RELATED APPLICATIONS

The present application claims priority to U.S. provisional application No. 62/937,624 filed Nov. 19, 2019, the entire contents of which are incorporated herein by reference.

### FIELD

The present invention relates generally to the field of Laser Capture Microdissection (LCM).

### BACKGROUND

Laser Capture Microdissection (“LCM”) (also called microdissection, laser microdissection (LMD), or laser-assisted microdissection (LMD or LAM)) is an established technology and method used to isolate a pure sample of a specific type of cells of interest (such as tumor cells) or entire areas of tissue (referred to herein generally as “target cells”) from a heterogeneous piece of tissue sample under direct microscopic visualization. The procured target cells may then be used in downstream applications, such as commercial diagnostic assays, clinical trials, and research studies by the pharmaceutical industry and academia. LCM is used by thousands of scientists worldwide and can be used in a variety of downstream applications such as genomics (DNA), transcriptomics (mRNA, miRNA), proteomics, metabolomics, gene expression and sequencing, determining molecular signatures, capillary electrophoresis, microarray analysis, polymerase chain reactions (PCR, such as qPCR or real time-PCR and proteomics), and next generation sequencing (NGS).

One form of LCM employs a laser beam or a source of radiation to heat a flat plastic film that is held against the slice of tissue sample mounted on a glass slide. The plastic film is uniformly impregnated with a dye that absorbs laser energy. The region of the plastic film positioned over the target cells is selectively heated by the radiation causing this region to melt and embed itself into the tissue segment immediately underneath. When the film is lifted off the tissue sample, the portions of the tissue adherent to the undersurface of the film are ripped free of the rest of the tissue sample (see, e.g., Espina V., et al. (2006) Nature Prot. 1(2):586-603, the entire disclosure of which is incorporated by reference herein in its entirety).

### SUMMARY

Various embodiments provide for a microscopy apparatus that comprises a microscope comprising a stage configured to hold a tissue sample, a UV laser assembly configured to emit a UV laser beam to a viewing area of the tissue sample, and an IR laser assembly configured to emit an IR laser beam to the viewing area of the tissue sample. The UV and IR laser assemblies are oriented so as to emit the respective UV and IR laser beams in a same direction.

Various other embodiments provide for a laser capture microdissection system that comprises a cap configured to adhere to target cells from a tissue sample when exposed to UV light and IR light and a microscopy apparatus. The microscopy apparatus comprises a microscope comprising a stage configured to hold the tissue sample and the cap, a UV laser assembly configured to emit a UV laser beam to a viewing area of the tissue sample, and an IR laser assembly configured to emit an IR laser beam to the viewing area of the tissue sample. The UV and IR laser assemblies are oriented so as to emit the respective UV and IR laser beams in a same direction.

Various other embodiments provide for a method of removing target cells from a tissue sample. The method comprises loading a tissue sample onto a stage of a microscope, selecting the target cells to be removed from the tissue sample, and placing a cap on the tissue sample, where the cap is configured to adhere to the target cells from the tissue sample when exposed to both the UV light and IR light. The method further comprises emitting a UV laser beam from a UV laser assembly to a viewing area of the tissue sample, emitting an IR laser beam from an IR laser assembly to the viewing area of the tissue sample, and removing the cap with the target cells adhered to the cap from a remainder of the tissue sample.

These and other features (including, but not limited to, retaining features and/or viewing features), together with the organization and manner of operation thereof, will become apparent from the following detailed description when taken in conjunction with the accompanying drawings, wherein like elements have like numerals throughout the several drawings described below.

### BRIEF DESCRIPTION OF THE DRAWINGS

FIG. 1 is a perspective view of a LCM system, according to one embodiment.

FIG. 2 is a perspective view of a microscope, according to one embodiment.

FIG. 3 is a perspective view of a stage of a microscope, according to one embodiment.

FIG. 4 is a side view of a camera, according to one embodiment.

FIG. 5 is a perspective view of a portion of a UV laser assembly, according to one embodiment.

FIG. 6 is a perspective view of a portion of an IR laser assembly, according to one embodiment.

FIG. 7 is a side, schematic view of a LCM system, according to one embodiment.

FIG. 8 is a side, schematic view of a LCM system, according to another embodiment.

FIG. 9 is a side, schematic view of a LCM system, according to another embodiment.

FIG. 10 is a side, schematic view of a LCM system, according to another embodiment.

FIGS. 11A-11E are perspective, front, and top views of a microscope, according to one embodiment.

FIGS. 12A-12D are perspective, side, and top views of a microscope, according to another embodiment.

### DETAILED DESCRIPTION

Referring to the figures generally, various embodiments disclosed herein relate to various apparatus, systems, and methods for laser capture microdissection (“LCM”) that utilize both ultraviolet (UV) and infrared (IR) laser beams, which allows for ultra-precise laser microdissection and ultra-sensitive analysis. By providing both the UV and IR laser beams, the user is given more choices for isolating pure cell populations for a variety of different LCM applications.

As used herein and in the appended claims, singular articles such as “a” and “an” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the embodiments and does not pose a limitation on the scope of the claims unless otherwise stated. No language in the specification should be construed as indicating any non-claimed element as essential.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified. The expression “comprising” means “including, but not limited to.” Thus, other non-mentioned substances, additives, carriers, or steps may be present. Unless otherwise specified, “a” or “an” means one or more.

Unless otherwise indicated, all numbers expressing quantities of properties, parameters, conditions, and so forth, used in the specification and claims are to be understood as being modified in all instances by the term “about.” Accordingly, unless indicated to the contrary, the numerical parameters set forth in the following specification and attached claims are approximations. Any numerical parameter should at least be construed in light of the number reported significant digits and by applying ordinary rounding techniques. The term “about” when used before a numerical designation, e.g., temperature, time, amount, and concentration including range, indicates approximations which may vary by (+) or (−) 10%, 5% or 1%.

As will be understood by one of skill in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like include the number recited and refer to ranges which can be subsequently broken down into subranges as discussed above. Finally, as will be understood by one skilled in the art, a range includes each individual member.

The purpose of the LCM technique is to provide a simple method for the procurement of certain target cells from a heterogeneous population or tissue sample contained on a typical histopathology biopsy slide. A typical tissue biopsy sample consists of a 5 to 10 micron slice of tissue that is placed on a microscope slide using techniques well known in the field of pathology. Often a pathologist desires to remove only a small portion of the tissue sample (e.g., the “target cells”) for further analysis.

The tissue sample may be a variety of different types or heterogeneous mix of cells and may be a variety of different tissue types from a variety of different organisms. For example, the tissue sample may comprise human cells and may be a cross section of the body organ that is being studied. The desired or selected regions, portions, sections, cells, or tissue of interest of the tissue sample that are to be removed from the rest of the tissue sample are referred to as the “target cells.”

In order to perform LCM, a film (such as a micropatterned thermoplastic film) is placed in contact with an upper surface of a tissue sample, while the undersurface of the tissue sample is mounted on a slide. To isolate certain target cells from the tissue sample, the film (in contact with the tissue sample) is then irradiated with electromagnetic radiation (i.e., laser energy). This film is a part of a consumable cap (as described further herein).

When the laser irradiation is directed over the desired region of the tissue sample (i.e., over the target cells), the irradiation alters the tissue sample adhesive properties. Along the upper surface of the tissue sample, the laser irradiation activates the adhesive capture along the upper surface of the tissue sample by activating the film. In particular, once the film is exposed to the focused laser beam, the exposed region of the film (and cap) that is in the beam of the laser energy is heated by the laser and locally melts. The melted area of the film embeds at the tissue sample surface, thereby adhering the exposed portion of the tissue sample (i.e., the desired target cells) to the film.

Meanwhile, the lower surface of the tissue sample, instead of directly resting on the slide, rests on a microparticle or nanoparticle coating (according to one embodiment) that can be altered in its adhesive properties by the laser energy alone or in combination with a chemical treatment of the tissue sample. The laser energy simultaneously activates the adhesive forces on the top surface of the tissue sample (as described above) while breaking or dissolving the adhesive force below the tissue sample. In particular, the adhesive capture is dissolved below the tissue sample to achieve a higher efficiency, precision of capture (with lower nonspecific capture), yield, and resolution.

After the laser irradiation, the film is then lifted from the tissue sample and removed. Since the selected target cells (immediately below the locally melted film area) are adhered to the film, the selected target cells of the tissue sample are removed with the film from the rest of the tissue sample. In particular, the target cells are torn off from and removed from the remainder of the tissue sample, which isolates the target cells from the rest of the tissue sample (or the target cells can be cut from the rest of the tissue sample). The target cells are captured and placed within a collection device to collect histologically pure, enriched cell populations from microscopic regions of tissue samples or cells.

The success of this operation is dependent on the balance of forces above the selected region of interest (i.e., between the film and the tissue sample) and below the selected region of interest (i.e., between the tissue sample and the slide). Various compositions and methods can increase the adhesive strength and improve the resolution of the film in contact with the tissue sample surface while at the same time selectively reducing the adhesive forces on the bottom of the tissue sample, where it can be tightly dried down on the slide.

As described further herein, the various embodiments disclosed herein allow the film (in contact with the tissue sample) to be irradiated with electromagnetic radiation in both the ultraviolet (UV) and infrared (IR) spectrum.

### LCM System

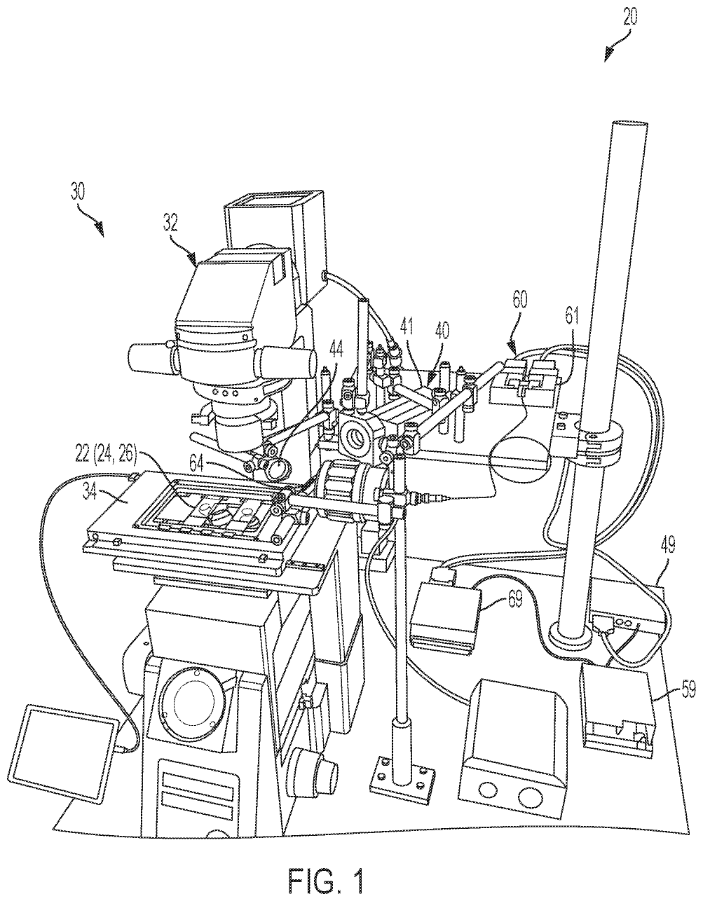

FIG. 1 shows one embodiment of a laser capture microdissection (LCM) system 20 that comprises a microscopy apparatus 30 and various consumables 22 (for upstream or downstream sample processing, for example). The various consumables 22 may include a cap 24 (that includes the film, as described further herein), slides 26 (e.g., a slide upon which the tissue sample is initially placed), and reagents (e.g., extraction reagents, staining reagents, and downstream reagents (to analyze the captured material)). The microscopy apparatus 30 comprises a microscope 32 and dual laser system that comprises a UV laser structure or assembly 40 and an IR laser structure or assembly 60.

By including both the UV laser assembly 40 and the IR laser assembly 60, the LCM system 20 provides performance improvements over conventional LCM systems. In particular, the resolution of the LCM system 20 is improved and smaller size regions of target cells can be accurately captured through microdissection within the tower of the microscope 32. By including both the UV laser assembly 40 and the IR laser assembly 60, the utility and use for additional applications of the LCM system 20 is expanded (compared to conventional LCM systems), and the LCM system 20 provides additional functionality not addressed or provided within conventional LCM systems that only use a single laser wavelength. Furthermore, higher quality images can be produced, while still being easily used to capture target cells.

The LCM system 20 allows a tissue microenvironment to be interrogated at a single cell level, provides high-fidelity visualization of the tissue (e.g., digital, full color images on a computer screen for selection by a mouse or stylus, for example), allows unique molecular signatures to be uncovered that would have otherwise been obscured in a heterogeneous cell population, and utilizes “GeckoGrip” caps with nanotechnology enhancements (as described further herein) for higher capture, extraction yields, and preservation.

Compared to conventional LCM systems, the LCM system 20 increases the speed of LCM with increased precision of targeting cells of interest, while maximizing flexibility. The LCM system 20 allows microdissected tissue samples to be maintained and in contact with a portion of the LCM system 20, while the bulk of the tissue is being imaged and cataloged for reference. The spatial orientation of the cells captured are maintained on the capture surface, thereby preserving the molecular integrity of the cells and shielding the biomolecules in the tissue sample from damage from the UV laser beam.

### Consumables of the LCM System

The LCM system 20 comprises a capture consumable or cap 24 with a film in order to perform the LCM. The cap 24 (via the film) is configured to adhere to target cells from the tissue sample when exposed to both the UV light and the IR light. The film may be a patterned (e.g., micropatterned) thermoplastic transfer film, such as those disclosed in U.S. Pat. No. 10,324,008, the entire disclosure of which is incorporated by reference herein in its entirety. The film may comprise “gecko feet” or projections, such as micropillars, micro projections, hydrogel microspheres, and/or microneedles that are attached to, continuous with, or integrally formed with a thermoplastic film, that is placed on top of the tissue sample. These projections allow for simultaneous capture and release and use micropattern surfaces for tissue and cell microdissection. The projections also improve the capture (e.g., lift) efficiency of pure populations of the target cells from the heterogeneous tissue sample by increasing the adhesive force between the top surface of the target cells and the film.

According to one embodiment, the projections may be formed on the film using a photolithography mold that is applied to the thermopolymer surface mounted on a thermopolymer extraction cap 24. The microscope 32 may include a weighted method to hold the cap 24 in place, which improves contact with the target cells. Optionally, the cap 24 may be manually placed onto the tissue sample, and the microscope 32 may comprise a cap placement system, such as a manual cap arm, to manually place the cap 24 with precision and stability. This improve the LCM polymer spot functionality (such as adherence to cells and spot diameter), allowing for smaller capture sizes.

The film (and optionally the projections) has surfaces that can be activated by selective radiant energy, such as from a laser beam, to become adhesive to an irregular tissue sample surface below. For example, the film (and optionally the projections) can be manufactured containing or impregnated with organic dyes (such as UV and/or IR absorbing dye) that are chosen to selectively absorb in the ultraviolet (UV) or infrared (IR) region of the spectrum overlapping the emission region of common laser diodes, e.g., AlGaAs laser diodes. By impregnating the projections (such as micropillars) with a gradient of laser absorbing dye, the tip of the projections can be made to swell and conform to the tissue sample surface irregularities selectively at the tip.

Additionally, LCM system 20 comprises the slide 26 that the tissue sample is mounted on. The slide 26 can also be modified by coating the slide 26 with microparticles or nanoparticles that can be altered in their tissue adhesive properties by laser irradiation. For example, the slide 26 can be coated with indium tin oxide to reduce adhesion forces between the bottom surface of the target cells and the slide 26 under the laser irradiation. The slide 26 may be constructed out of a variety of different materials, including but not limited to glass or membrane (e.g., glass membrane or metal membrane).

### Microscope

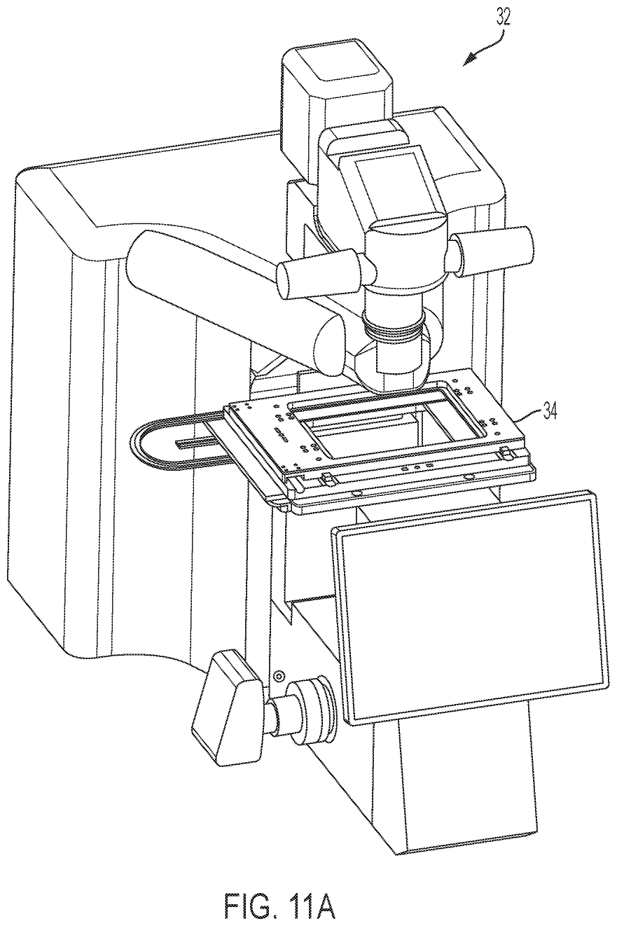

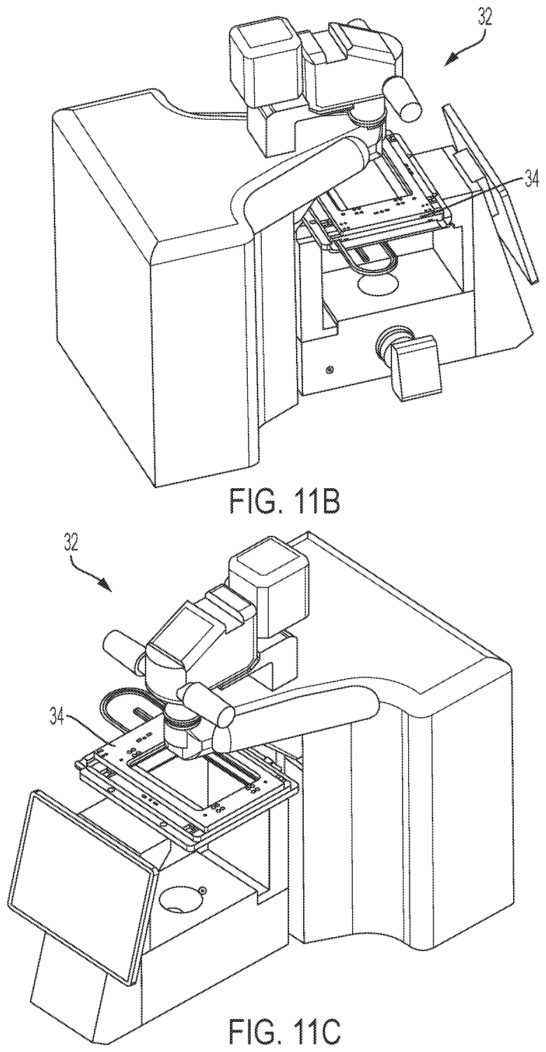

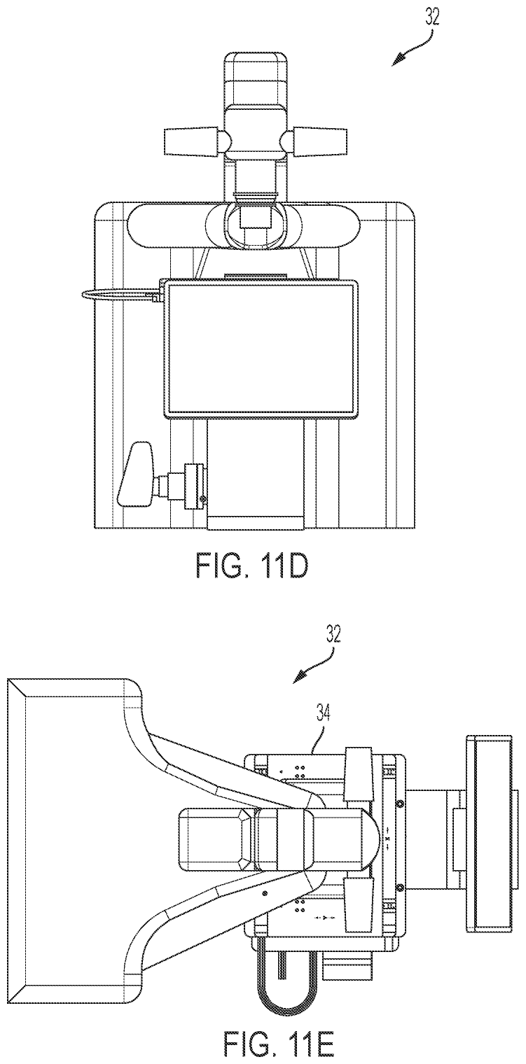

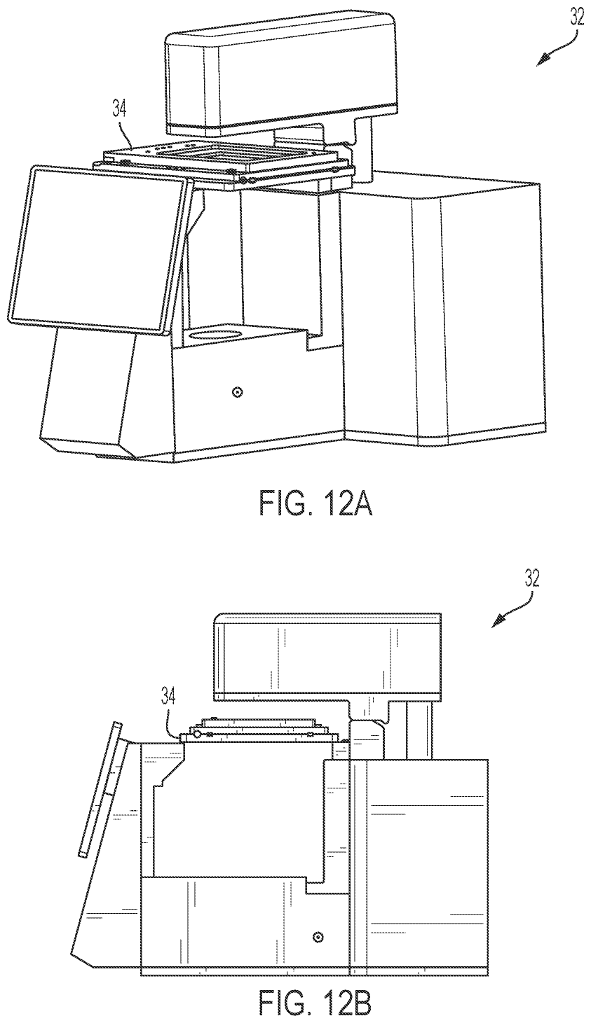

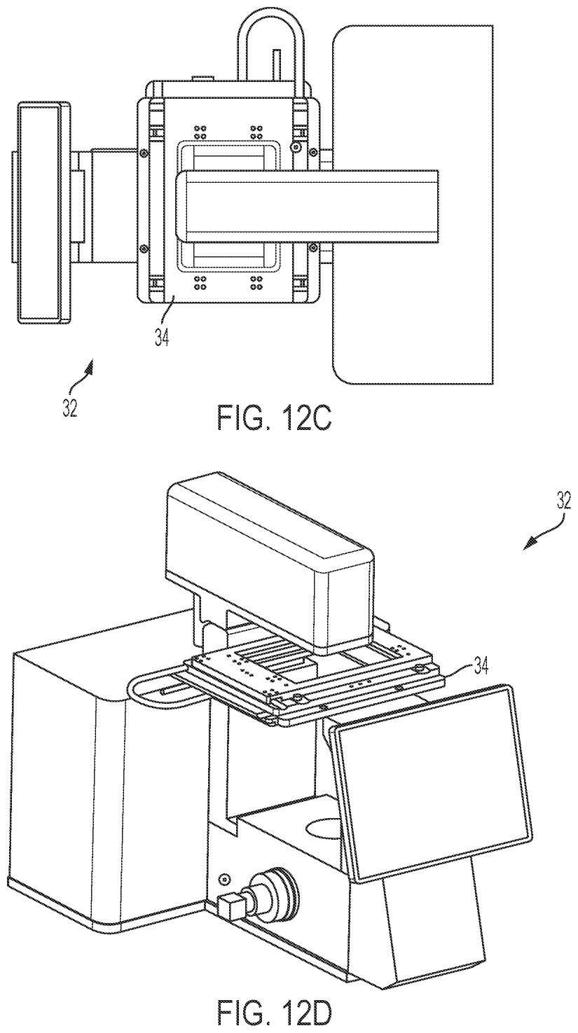

The microscope 32 allows the tissue sample (or the target cells) to be easily magnified, viewed or visualized, and captured (as an image) at, for example, 2×, 10×, and 40× magnification. The microscope 32 may provide digital microscopy and may include various features, such as marks for image alignment, on-screen feature selection, automatic or manual microdissection, intuitive, user-friendly operator software, and integrated telepathology options. The microscope 32 may provide high fidelity color visualization of the tissue sample by refractive index matching at the interface with capture surface. FIGS. 11A-11E show one embodiment of a microscope 32, and FIGS. 12A-12D show another embodiment of a microscope 32.

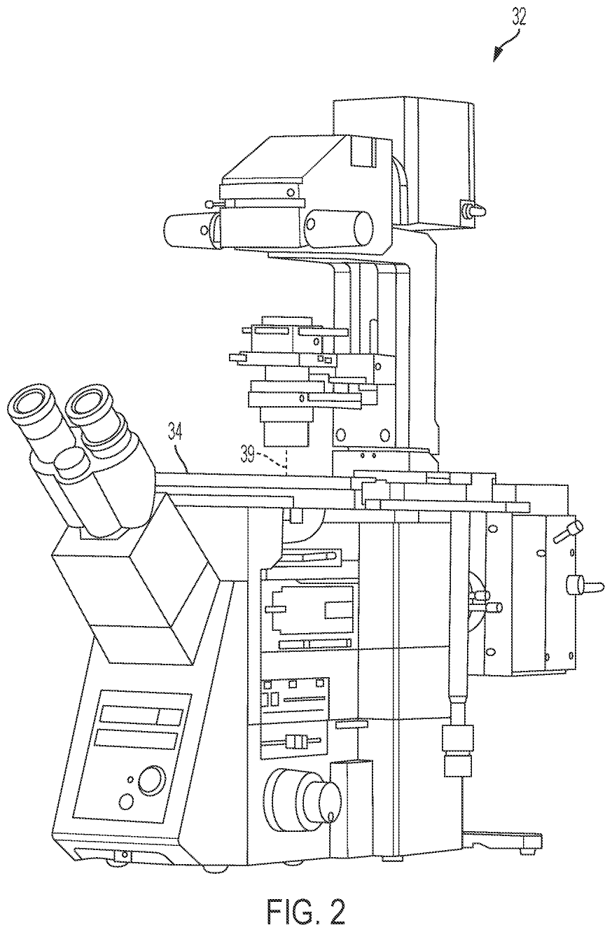

According to one embodiment, the base of the microscope may be an Olympus ix73 inverted microscope with 2×, 10×, and 40× objectives and long-working distance condenser (and without any binoculars installed), as shown in FIG. 2.

The microscope 32 defines an optical axis 39 that defines a path along which light propagates through the microscope 32 to the tissue sample. The optical axis 39 coincides with and extends through the middle of the field of view (or viewing area or region) of the tissue sample. The optical axis 39 passes through the center of curvature of each of the lens of the microscope 32 (and through any mirrors of the laser assemblies 40, 60). As referred to herein, the “path of light” refers to the direction that both visible light and the laser beams 42, 62 are emitted toward the tissue sample and the stage 34.

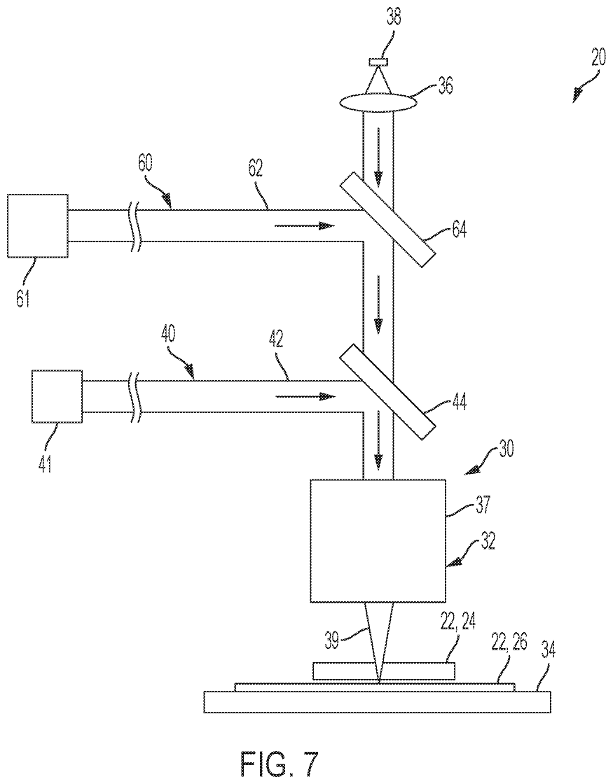

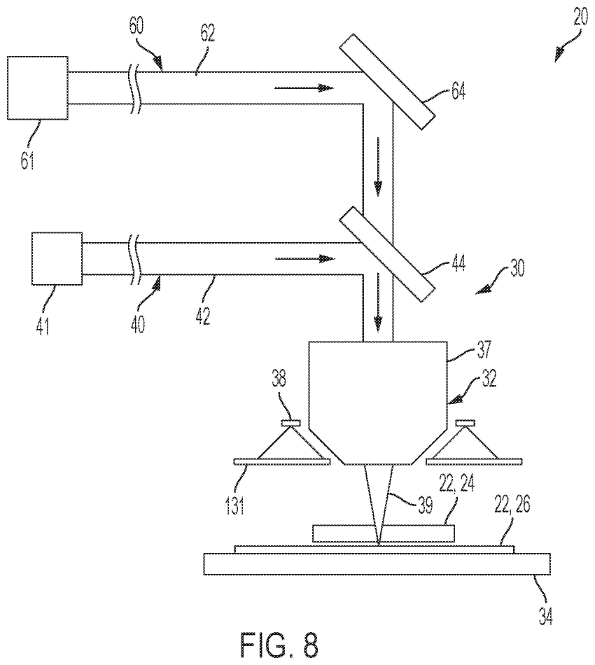

The microscope 32 may comprise an illumination or light source 38 (as shown in FIGS. 7-8) that emits visible light toward the viewing area to illuminate the tissue sample. The light source 38 may be positioned above the stage 34. According to various embodiments, the light source 38 may be a white light-emitting diode (LED). According to one embodiment as shown in FIG. 8, the light source 38 may be a ring of lights (e.g., a ring of LEDs), and the microscope 32 may include a diffuser 131 (such as an annular ground glass diffuser) that is positioned directly beneath the light source 38 to diffuse the light.

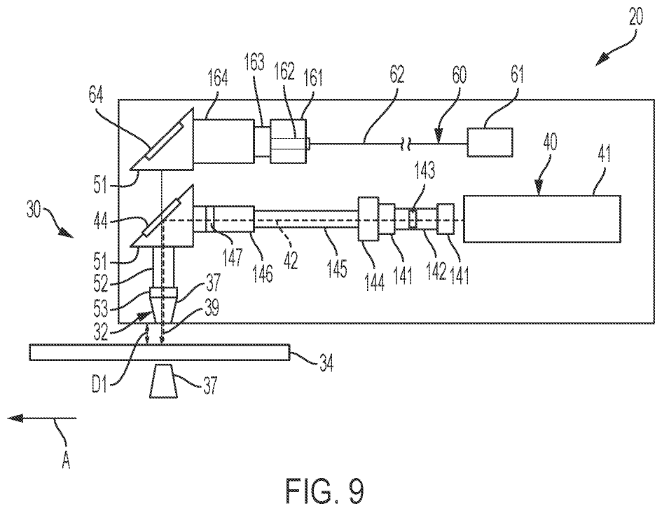

The microscope 32 comprises a variety of different lens, including at least one condenser lens 36 and at least one objective lens 37 (as shown in FIG. 7). According to one embodiment, the microscope 32 includes two condenser lens 36. The objective lens 37 may be a low-magnification reflective objective lens (such as Thorlabs LMM-15X-UVV or a 10× objective lens with a relatively long working distance of approximately 30 millimeters (mm)). The microscope 32 may include multiple different types of objective lens 37, such as a reflective objective lens positioned above the stage 34 and a viewing objective positioned below the stage 34 (as shown in FIG. 9). The objective lens 37 may have a variety of different magnifications, including between 2× to 100×.

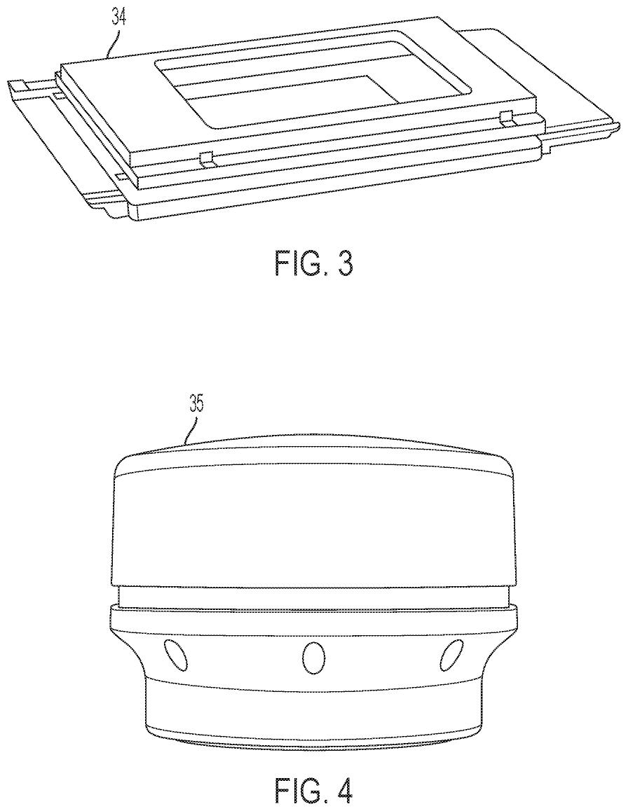

As shown in FIGS. 2-3, the microscope 32 comprises a motorized instrument platform or stage 34 configured to hold the tissue sample. The tissue sample (and the slide 26) can be loaded or placed on top of the stage for analysis and dissection by the lasers. The stage 34 can be moved (manually or by a computer) relative to the rest of the microscope 32 in order to position the tissue sample in the desired position. For example, the stage 34 may be moved vertically to position the tissue sample a certain vertical distance from the lens of the microscope 32. The stage 34 may also be moved along a horizontal plane to position a particular portion of the tissue sample (i.e., the target cells) in the field of view (aligned with the optical axis 39) and beneath the lasers for dissection. The microscope 32 may optionally include a stage controller to control movement of the stage 34. According to one embodiment as shown in FIG. 3, the stage 34 is a Thorlabs MLS203-1 linear stage (up to 250 mm/sec speed with a 0.25 micrometers (μm) repeatability).

As shown in FIG. 4, the microscope 32 may comprise a camera 35 that is configured to digitally capture color images of the tissue sample and may be a forward-looking infrared (FLIR) camera. According to one embodiment as shown in FIG. 4, the camera 35 is an Olympus DP74, which combines a wide field of view with a diagonal length of 21 mm with full HD image resolution at 60 frames per second (fps). The global shutter of the Olympus DP74's complementary metal oxide semiconductor (CMOS) exposes the entire pixel at once, eliminating distortion. The Olympus DP74 has a built-in position navigator that can be integrated with the software of the LCM system 20. According to one embodiment, the camera 35 may be positioned outside of the optical axis 39, and a camera mirror may be positioned and angled to allow the camera 35 to capture and record images or a video of the tissue sample under the microscope 32.

### Laser Assemblies

The UV laser assembly 40 and the IR laser assembly 60 of the dual laser system are both solid state and emit laser beams at different wavelengths and different energies for a wide range of applications. The UV laser assembly 40 and the IR laser assembly 60 can capture single cells or small groups of cells, microdissect complicated multicellular shapes, extract large tissue areas, and be used with a variety of tissue samples, including frozen sections, paraffin embedded sections, and live cells (and accordingly may optionally include phase contrast and Dic options for live-cell applications). According to one embodiment, the UV laser assembly 40 and the IR laser assembly 60 are both positioned outside of the optical axis 39 of the microscope 32 and have a fixed laser focus.

As shown in FIG. 7, the UV laser assembly 40 comprises a UV laser 41 (which may be within a UV laser head) (e.g., a UV laser emitter) configured to deliver, emit, or output a UV laser beam 42 to a viewing area of the tissue sample. The UV laser beam 42 offers superior speed and precision and is well-suited for microdissecting dense tissue structures (in particular when large number of cells are to be harvested) and for rapidly capturing single cells or subcellular structures given its small spot size (relative to the IR laser beam 62). Due to the positioning of the UV laser assembly 40 and the IR laser assembly 60 relative to the microscope 32 (such as positioning the laser beams 42, 62 within the tower or optical axis 39 of the microscope 32, as described further herein) allows for increased resolution due to shorter a shorter UV wavelength, thus permitting smaller capture sizes for single cells and small numbers of cells. According to various embodiments, the UV laser beam 42 may have a wavelength of 355 nanometers (nm). According to one embodiment, the diameter of the UV laser beam 42 may be approximately 8-12 mm.

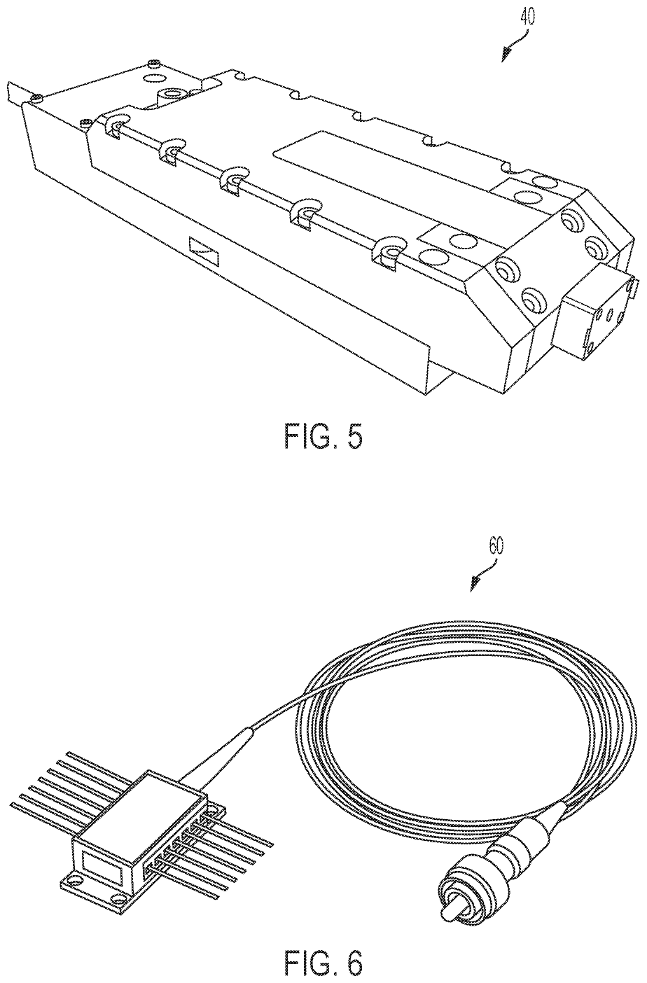

In addition to tissue cutting, the UV laser assembly 40 may also be used to perform UV LCM, similar to the operation of the IR laser assembly 60. Comparatively, in conventional LCM systems that incorporate a UV laser, the UV laser is only used for tissue cutting, rather than capturing direct cap-based tissue. According to one embodiment as shown in FIG. 5, the UV laser assembly 40 is a TeemPhotonics SNV-20E-10x, 355 nm (with 19 kHz pulse frequency and 10 mW power output).

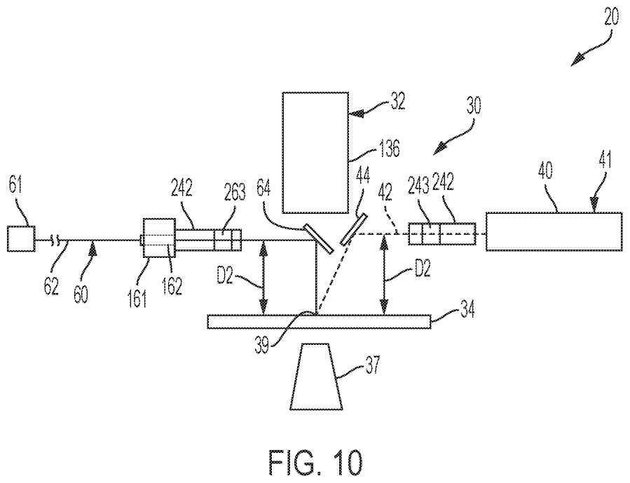

The UV laser assembly 40 includes a single UV mirror 44 configured to change a direction of the UV laser beam 42 emitted from the UV laser 41. The UV mirror 44 is configured to redirect the path of the UV laser beam 42 from the UV laser 41 to the viewing area of tissue sample along the stage 34. Accordingly, the UV laser beam 42 is initially emitted from the UV laser 41 in a first direction, travels in the first direction between the UV laser 41 and the UV mirror 44, bounces off and is deflected by the UV mirror 44 (which redirects the path of the UV laser beam 42), subsequently travels in a second direction between the UV mirror 44 and the tissue sample and the stage 34, and contacts the viewing area of the tissue sample while traveling in the second direction. The first and second directions may be substantially perpendicular to each other (i.e., horizontal and vertical directions, respectively, as shown in FIGS. 7-9) or may be at an oblique angle to each other (as shown in FIG. 10).

With the UV mirror 44, the UV laser 41 can be positioned outside of the optical axis 39 of the tissue sample within the microscope 32. The first direction of the UV laser beam 42 may be substantially parallel to the top surface of the stage 34 (although, according to other embodiments, the UV laser beam 42 may initially be emitted at other angles to the stage 34 and the angle of the UV mirror 44 is adjusted accordingly).

Depending on the arrangement of the microscopy apparatus 30, the UV mirror 44 may allow certain wavelengths of light to be transmitted through (while deflecting the UV laser beam 42). For example, as shown in FIG. 7, the UV mirror 44 may be positioned between the light source 38 (or the scope condenser head 136 as shown in FIG. 10) and the tissue sample (or the stage 34) along the optical axis 39. The UV mirror 44 is also positioned below the IR mirror 64 along the light path and the optical axis 39. Accordingly, the UV mirror 44 is transparent to both visible light and IR light, and both the visible light and the IR light can pass directly through the UV mirror 44. According to one embodiment, the UV mirror 44 may be a CVI Laser Optics Y3-1025-45 mirror. The UV laser beam 42 and IR laser beam 62 are oriented in a same direction, in at least one embodiment (e.g., as seen in FIG. 7). In at least one embodiment, the UV and IR laser assemblies are oriented so as to emit the respective UV and IR laser beams in a same direction (e.g., at a same angle) relative to the sample.

As shown in FIG. 7, the IR laser assembly 60 comprises an IR laser 61 (which may be within an IR laser head) (e.g. an IR laser emitter) configured to deliver, emit, or output an IR laser beam 62 to a viewing area of the tissue sample. The IR laser beam 62 provides a gentle capture technique that preserves the biomolecular integrity of the target cells and is ideal for relatively large populations of cells due to its large spot size (relative to the UV laser beam 42). The IR laser beam 62 is ultra-sensitive and is particularly advantageous for capturing single cells and small areas of interest with high precision. According to one embodiment as shown in FIG. 6, the IR laser assembly 60 is a Thorlabs FPL808S (continuous wave, 250 mW) that delivers an IR laser beam 62 with an approximately 808 nm wavelength. According to one embodiment, the diameter of the IR laser beam 62 may be approximately 8-12 mm.

The IR laser assembly 60 includes a single IR mirror 64 configured to change a direction of the IR laser beam 62 emitted from the IR laser 61. The IR mirror 64 is configured to redirect the path of the IR laser beam 62 from the IR laser 61 to the tissue sample to the viewing area of tissue sample along the stage 34. Accordingly, the IR laser beam 62 is initially emitted from the IR laser 61 in a first direction, travels in the first direction between the IR laser 61 and the IR mirror 64, bounces off and is deflected by the IR mirror 64 (which redirects the path of the IR laser beam 62), subsequently travels in a second direction between the IR mirror 64 and the tissue sample and the stage 34, and contacts the viewing area of the tissue sample while traveling in the second direction. The first and second directions may be substantially perpendicular to each other (i.e., horizontal and vertical directions, respectively, as shown in FIGS. 7-10).

With the IR mirror 64, the IR laser 61 can be positioned outside of the optical axis 39 of the tissue sample within the microscope 32. The first direction of the IR laser beam 62 may be substantially parallel to the top surface of the stage 34 (although, according to other embodiments, the IR laser beam 62 may initially be emitted at other angles to the stage 34 and the angle of the IR mirror 64 is adjusted accordingly).

Depending on the arrangement of the microscopy apparatus 30, the IR mirror 64 may allow certain wavelengths of light to be transmitted through (while deflecting the IR laser beam 62). For example, as shown in FIG. 7, the IR mirror 64 may be positioned between the light source 38 (or the scope condenser head 136 as shown in FIG. 10) and the tissue sample (or the stage 34) along the optical axis 39. The IR mirror 64 is positioned above the UV mirror 44 along the light path and the optical axis 39. Accordingly, the IR mirror 64 is transparent to visible light, and the visible light can pass directly through the IR mirror 64. According to one embodiment, the IR mirror 64 is the Thorlabs BB1-E03 IR laser line mirror. In particular, as the Thorlabs BB1 EO3 IR laser line mirror is not transparent to visible light, it is suitable for certain configurations such as shown in FIG. 8. The IR laser beam 62 may optionally be transmitted from the IR laser 61 to the IR mirror 64 through an IR fiber or cable.

According to one embodiment, the UV laser assembly 40 and the IR laser assembly 60 each comprise only one mirror (i.e., the UV mirror 44 and the IR mirror 64, respectively). As shown in FIG. 9, the UV mirror 44 and the IR mirror 64 may each be mounted onto a mirror mount 51. Each of the mirror mounts 51 may be adjustable to steer or direct the respective UV laser beam 42 and IR laser beam 62. For example, by moving the mirror mount 51 and thus the IR mirror 64, the IR laser beam 62 may be moved to be co-aligned at the focus with the UV laser beam 42. According to one embodiment, the mirror mounts 51 are the Thorlabs KCB1 mirror mounts and are configured to position the mirrors 44, 64 at approximately 45° in order to redirect the laser beams 42, 62 at approximately 90° relative to their original direction.

The UV laser assembly 40 and the IR laser assembly 60 may optionally be configured to emit the UV laser beam 42 and the IR laser beam 62, respectively, at the same time. The UV laser beam 42 and the IR laser beam 62 are emitted horizontally from the UV laser 41 and the IR laser 61, respectively, as collimated beams. The UV laser assembly 40 and the IR laser assembly 60 may optionally include multiple focusing lens to expand the collimated beams and then refocus the beams or may include a beam expander. As described further herein, the UV laser beam 42 and the IR laser beam 62 are each focused through at least one lens (such as the condenser lens 36), deflected off of a respective mirror 44, 64, and directed vertically downward to the viewing area along the stage 34.

As shown in FIG. 1, the UV laser assembly 40 comprises a UV laser controller 49, and the IR laser assembly 60 comprises an IR laser controller 69. The UV laser controller 49 and the IR laser controller 69 are configured to control (via the computer system, as described further herein) and power the UV laser 41 and the IR laser 61, respectively, and may include various light indicators to indicate the respective status of the UV laser 41 and the IR laser 61. The backends of the UV laser 41 and the IR laser 61 are connected to the UV laser controller 49 and the IR laser controller 69, respectively. A power supply unit 59 (such as a 12 VDC power supply) may be connected to each of the UV laser controller 49 and the IR laser controller 69 to provide power to the UV laser assembly 40 and the IR laser assembly 60 via the UV laser controller 49 and the IR laser controller 69. A USB control relay may send control signals to the UV laser controller 49 and the IR laser controller 69 from the computer system. The microscopy apparatus 30 may further include a case fan to cool the system.

In some embodiments, each of the UV and IR laser controllers 49, 69 includes a central processing unit (CPU), a read only memory (ROM), and a random access memory (RAM) 103. The CPU is connected to the ROM and the RAM via a bus line. The CPU is configured to store at least one control program stored in the ROM or the memory unit in the RAM. The CPU controls operation of one or more of the laser or power supply by operating according to the control program.

For the UV laser beam 42 and the IR laser beam 62, suitable laser pulse widths may be from 0 to approximately 1 second, preferably from 0 to approximately 100 milliseconds, more preferably approximately 50 milliseconds. In at least one embodiment, the pulses from the UV laser beam 42 and IR laser beam 62 are phased such that they never overlap. The UV laser beam may be off when the IR laser beam is on, and vice versa, such that UV and IR energy are never emitted simultaneously. The spot size of the UV laser beam 42 and the IR laser beam 62 at the film located on microcentrifuge tube cap is variable from 0.1 to 100 microns, preferably from 1 to 60 microns, more preferably from 5 to 30 microns. These ranges are relatively preferred when designing the optical subsystem. From the standpoint of the clinical operator, the widest spot size range is the most versatile. A lower end point in the spot size range on the order of 5 microns is useful for transferring single cells.

The UV laser beam 42 and the IR laser beam 62 may have a wide power range. For example, a 100 milliwatt laser can be used for at least one of the UV or IR laser beam. In some embodiments, a 50 mW laser can be used for at least one of the UV or IR laser beam. The UV laser beam 42 and the IR laser beam 62 can be connected to the rest of the optical subsystem with a fiber optical coupling. Smaller spot sizes are obtainable using diffraction limited laser diodes as the emitters and/or single mode fiber optics. Single mode fiber allows a diffraction limited beam.

Changing the beam diameter of the UV laser beam 42 and the IR laser beam 62 permits the size of the portion of the sample that is acquired to be adjusted. Given a tightly focused initial condition, the beam size can be increased by defocusing. Given a defocused initial condition, the beam size can be decreased by focusing. The change in focus can be in fixed amounts. The change in focus can be obtained by means of indents on a movable lens mounting and/or by means of optical glass steps. In any event, increasing/decreasing the optical path length is the effect that is needed to alter the focus of the beam, thereby altering the spot size. For example, inserting a stepped glass prism into the beam so the beam strikes one step tread will change the optical path length and alter the spot size.

Optionally, the microscopy system may include an extendable platform to provide optional UV laser cutting and epifluorescence.

### LCM System Setup

The LCM system 20 may be set up in a variety of different configurations and arrangements, depending on the desired use and setup configuration. According to various embodiments as shown in FIGS. 7-9, both the UV laser 41 and the IR laser 61 are positioned outside of the optical axis 39 of the microscope 32 (and optionally may be on the same side of the microscope 32). Both the UV mirror 44 and the IR mirror 64 are positioned along the optical axis 39 of the microscope 32, directly above the viewing area of the tissue sample. The IR mirror 64 is positioned directly above the UV mirror 44 along the path of light and the optical axis 39. The UV mirror 44 and the IR mirror 64 are in series with each other, the condenser (such as the condenser lens 36), and the objective lens 37. Both the UV laser beam 42 and the IR laser beam 62 pass and are focused through a single objective lens 37.

With this configuration, after the UV laser beam 42 and the IR laser beam 62 are each redirected by their respective mirrors 44, 64, the UV laser beam 42 and the IR laser beam 62 extend along the optical axis 39 of the microscope 32 to the stage 34, parallel to each other. Both the UV laser beam 42 and the IR laser beam 62 contact the viewing area of the tissue sample and the stage 34 at an approximately normal angle (and parallel to the optical axis 39). By arranging the UV laser beam 42 and the IR laser beam 62 to contact the viewing area along the stage 34 (and therefore extend through the cap 24) at a normal angle, the UV laser beam 42 and the IR laser beam 62 can be tightly focused. In order to position both the UV mirror 44 and the IR mirror 64 within the optical axis 39 (such that the UV laser beam 42 and the IR laser beam 62 are parallel to each other before and after their respective redirection by the mirrors 44, 64), the UV mirror 44 and the IR mirror 64 are at approximately the same angle as each other.

According to the embodiment shown in FIG. 7, the light source 38 is positioned above the condenser lens 36, which is positioned above the UV mirror 44 and the IR mirror 64 along the path of light and the optical axis 39. The objective lens 37 is positioned between the UV mirror 44 and the cap 24 (with the cap 24 positioned along and on top of the slide 26, which is positioned on top of the stage 34). Accordingly, both the UV laser 41 and the IR laser 61 emit the UV laser beam 42 and the IR laser beam 62, respectively, toward the UV mirror 44 and the IR mirror 64, respectively. The UV mirror 44 and the IR mirror 64 redirect the respective laser beams 42, 62 downward along the optical axis 39 through the objective lens 37, through the cap 24, and to the viewing area of the tissue sample on the slide 26 on the stage 34. The visible light from the light source 38 transmits through the condenser lens 36, the IR mirror 64, the UV mirror 44, the objective lens 37, the cap 24, and to the viewing area of the tissue sample. The configuration of FIG. 7 is relatively resistant to vibration and provides sufficient working room between the bottom of the objective lens 37 and the top of the tissue sample on the stage 34 (such as approximately 1 inch). Furthermore, the setup of FIG. 7 provides an illumination radius of the viewing area of the tissue sample of approximately 1.5-2 mm.

According to the embodiment shown in FIG. 8, the LCM system 20 includes a similar arrangement to that of FIG. 7, except the light source 38 of the microscope 32 is ring of lights positioned and extending around the outside of the objective lens 37, outside of the optical axis 39, creating an illumination ring. Since the light source 38 is positioned along the outside of the objective lens 37, the light source 38 is positioned vertically below the mirrors 44, 64. The ring of lights may optionally include a diffuser, and/or each of the lights may be angled radially inward to illuminate the center of the viewing area. The ring of lights may be approximately 1.25 inches above the top surface of the stage 34. This configuration simplifies the overall setup and reduces the cost of the optics and mounting since there is no need for a light source above the mirrors 44, 64. Alternatively, the light source 38 may be positioned along other areas outside the optical axis 39 and directed to the viewing field of the tissue sample along the stage 34, and/or the light source 38 may be part of an epi-illumination port on the microscope 32.

The setup of FIG. 8 may allow for darkfield, rather than brightfield, illumination since the illumination rays from the light source 38 enter into the tissue sample and the inspection objective lens at an angle (rather than straight through), thereby increasing the contrast of the tissue sample being viewed. However, other embodiments of the LCM system 20 may provide brightfield illumination.

According to the embodiment shown in FIG. 9, after being redirected by their respective mirrors 44, 64, both the UV laser beam 42 and the IR laser beam 62 are directed through a translating tube 52 (such as the Thorlabs SM1NR1 translating tube with the Thorlabs SM1 tube threaded therein), through a zoom housing 53 (such the Thorlabs SM1ZM high-precision zoom housing with a RMS adapter threaded there), through an objective lens 37 (in particular a reflective objective lens), and subsequently to the stage 34. Another objective lens 37 (in particular a viewing or inspection objective lens) is positioned below the stage 34. According to one embodiment, the bottom end of the objective lens 37 may be a distance D of approximately 30.5 mm away from the top surface of the stage 34. For reference, the arrow A in FIG. 9 is pointing in the direction of the front of the LCM system 20.

As further shown in FIG. 9, the UV laser assembly 40 may include a variety of different components to manipulate the UV laser beam 42. For example, the UV laser assembly 40 may include various irises 141 (such as the Thorlabs SM05D5 Iris and/or the Thorlabs SM1D12 Iris), a zoom lens tube 142 (such as the Thorlabs SM1NR05 zoom lens tube) with a plano-concave lens 143 (such as the Thorlabs LC4291-UV, −12 mm lens or the Thorlabs LC4924-UV with a −20 mm focal length) in an adapter (such as the Thorlabs SM05 to SM1 adapter), a gimbal mount 144 (such as the Thorlabs GMB100 gimbal mount), a tube 145 (such as the Thorlabs 4 inch SM1 tube), and a lens tube 146 (such as the Thorlabs SM1L30C open-sided lens tube) with a plano-convex lens 147 (such as the 1 inch, Thorlabs LA4924-UV, UV-coated, plano-convex lens, with a focal length of approximately 175 mm). As the UV laser beam 42 is emitted from the UV laser 41, the UV laser beam 42 travels through the first iris 141, the plano-concave lens 143 within the zoom lens tube 142, the second iris 141, the gimbal mount 144, the tube 145, the plano-convex lens 147 within the lens tube 146, and to the UV mirror 44, at which point the direction of the UV laser beam 42 is redirected downward to the stage 34. The various lens may be made of UV fused silica or of N-BK7, which can transmit 355 nm of light.

As also shown in FIG. 9, the IR laser assembly 60 may also include a variety of different components to manipulate the IR laser beam 62. For example, the IR laser assembly 60 may include a 5-axis kinematic collimator mount 161 (such as Thorlabs K5X1 kinematic mount) with a triplet collimator 162 (such as Thorlabs TC25APC-850 triplet collimator), a lens tube 163 (such as Thorlabs SM1 L05 lens tube), and a beam expander 164 (such as Thorlabs GBE02-B 2× beam expander). As the IR laser beam 62 is emitted from the IR laser 61, the IR laser beam 62 travels through the triplet collimator 162 within the collimator mount 161, through the lens tube 163, through the beam expander 164, and to the IR mirror 64, at which point the direction of the IR laser beam 62 is redirected downward to the stage 34.

According to another embodiment, the IR laser assembly 60 may not include any IR mirrors, such as the IR mirror 64. Instead, the IR laser beam 62 may be emitted (from the IR fiber, for example) from the IR laser 61 directly parallel to and along the optical axis 39. Accordingly, the triplet collimator 162 (with its collimator mount 161) may be threaded directly onto an expander (such as, for example only, a 2× expander for an IR laser beam 62 with a width of approximately 11 mm) and vertically mounted such that the triplet collimator 162 points directly down along the optical axis 39 through the objective lens 37 (i.e., the reflective objective).

FIG. 10 shows another embodiment in which only the IR mirror 64 is positioned along the optical axis 39 of the microscope 32 (and within a column of visible light from a scope condenser head 136 to the viewing area of the tissue sample on the stage 34), directly beneath the scope condenser head 136 and directly above the viewing area of the tissue sample. The UV mirror 44 is positioned outside of the optical axis 39 (and outside the column of visible light from the scope condenser head 136), is not directly beneath the condenser head 136, and is not directly above the viewing area of the tissue sample. Accordingly, the IR laser beam 62, after being redirected by the IR mirror 64, extends along the optical axis 39 to the stage 34 and contacts the viewing area of the tissue sample and the stage 34 at an approximately normal angle (and parallel to the optical axis 39). The UV laser beam 42, however, after being redirected by the UV mirror 44, does not extend along the optical axis 39, but instead extends at a non-parallel angle to the optical axis 39 and the IR laser beam 62 and contacts the viewing area of the tissue sample and the stage 34 at an oblique angle. By arranging the UV laser assembly 40 such that the UV laser beam 42 contacts the viewing area along the stage 34 at an oblique angle, the user can see the effects of the UV laser beam 42 more easily in real time. In order to position the UV mirror 44 outside of the optical axis 39 (and the UV laser beam 42 at an angle to the IR laser beam 62 after respective redirection), the UV mirror 44 is at a different angle than the IR mirror 64.

In the embodiment of FIG. 10, both the UV laser 41 and the IR laser diode 61 are positioned outside of the optical axis 39 of the microscope 32. The UV laser 41 and the IR laser 61 may be positioned along different sides of the microscope 32. Although the UV laser 41 and the IR laser 61 are shown on opposite sides of the microscope 32, the UV laser 41 and the IR laser 61 may be positioned at approximately 90° from each other about the optical axis 39 to prevent the UV laser beam 42 and the IR laser beam 62 from contacting each other (and may be positioned at least partially behind the microscope 32).

As shown in FIG. 10, with this configuration, the UV laser assembly 40 may also include a variety of different components to manipulate the UV laser beam 42. For example, the UV laser assembly 40 may include an adjustable telescoping lens tube 242 (such as the Thorlabs SM1NR1 adjustable telescoping lens tube with the Thorlabs SM1 tube threaded therein) with an achromatic doublet 243 (such as the Thorlabs ACA254-200, 1 inch, UV achromatic doublet, with a focal length of approximately 200 mm) that the UV laser beam 42 is directed to prior to reaching the UV mirror 44. With this configuration, the UV mirror 44 may be the Thorlabs NB1-K07 UV laser-line mirror. As the UV laser beam 42 is emitted from the UV laser 41, the UV laser beam 42 passes through the achromatic doublet 243 within the telescoping lens tube 242 and travels to and bounces off of the UV mirror 44, at which point the direction of the UV laser beam 42 is redirected or deflected downward to the stage 34 to the viewing area.

As also shown in FIG. 10, the IR laser assembly 60 may also include a variety of different components to manipulate the IR laser beam 62. For example, the IR laser assembly 60 may include the collimator mount 161 with the triplet collimator 162 and the telescoping lens tube 242 with an achromatic doublet 263 (such as the Thorlabs ACA254-200, 1 inch, IR achromatic doublet, with a focal length of approximately 200 mm) that the IR laser beam 62 is directed to prior to reaching the IR mirror 64. With this configuration, the IR mirror 64 may be a dichroic mirror that reflects IR light and is transparent to visible light, such as the Thorlabs DMSP750B dichroic mirror. As the IR laser beam 62 is emitted from the IR laser 61 (and through a fiber), the IR laser beam 62 passes through the triplet collimator 162 within the collimator mount 161 (with an exit beam size of approximately 5.4 mm, according to one embodiment) and through the achromatic doublet 263 in the telescoping lens tube 242 and then travels to and bounces off of the IR mirror 64, at which point the direction of the IR laser beam 62 is redirected or deflected downward to the stage 34 to the viewing area.

In the embodiment shown in FIG. 10, the microscope 32 includes a scope condenser head 136 that is positioned above the IR mirror 64 (such that the IR mirror 64 is between the condenser lens 36 and the stage 34) along the optical axis 39 and along the path of light toward the stage 34. The objective lens 37 is positioned beneath the stage 34. According to one embodiment, the UV laser beam 42 and the IR laser beam 62 may each be at a distance D2 of approximately 3 inches above the stage 34 prior to being redirected by their respective mirrors 44, 64.

According to one embodiment, the diameter of the UV laser beam 42 in the setup of FIG. 10 may be relatively small, such as approximately 1 mm. Since the focal length of the achromatic doublet 243 is relatively large (i.e., approximately 200 mm), the focal spot is relatively large, and the waist diameter around the focus is approximately 90 μm and is insensitive to translation of the telescoping lens tube 242.

The achromatic doublets 243 and 263 allow the laser beams 42, 62 to be focused before contacting the respective mirrors 44, 64. Alternatively, instead of the achromatic doublets 243 and 263, aspheres (such as the Thorlabs AL50100H-B, 2 inch aspheric lens) may be used.

According to one embodiment, the microscopy apparatus 30 may not include the UV laser assembly 40, and may only include the IR laser assembly 60 as its only laser source. The IR laser assembly 60 may have any of the various configurations, components, and features described herein.

The various embodiments disclosed herein (in particular, but not limited to the embodiments shown in FIGS. 7-10) may include any the various features, components, configurations, aspects, of each other, unless otherwise noted in the description herein.

### LCM System Operation

In order to perform LCM in and operate the LCM system 20 (in particular to remove target cells from a tissue sample), the slide is prepared (and the tissue sample is optionally stained), and the tissue sample is loaded or placed onto the stage 34 of the microscope 32 and visually inspected through the microscope 32 (and optionally through an associated computer monitor) to identify the target cells of interest. The target cells of the tissue sample to be dissected and removed from the rest of the tissue sample through laser dissection are located, selected, outlined, and traced (on, for example, the computer monitor with freehand drawings tools) to designate which portions of the tissue sample should be microdissected. The stage 34 of the microscope 32 is moved (with the tissue sample) along a horizontal plane relative to the rest of the microscope 32 (and the rest of the microscopy apparatus 30) to position the target cells in the paths of the UV laser beam 42 and the IR laser beam 62. The operator may manually place the cap 24 (which includes the film) onto the cap holder or arm, and the cap 24 is pressed or placed onto the tissue sample (and the slide 26). The UV laser assembly 40 and the IR laser assembly 60 may optionally be test fired.

Via software, the operator activates the UV laser assembly 40 and the IR laser assembly 60, which emits the UV laser beam 42 and the IR laser beam 62, respectively, to the viewing area of the tissue sample (via a diascopic illumination pillar according to one embodiment). As described further herein, the UV mirror 44 and the IR mirror 64 change the direction of the UV laser beam 42 and the IR laser beam 62, respectively, as the UV laser beam 42 and the IR laser beam 62 travel from the UV laser 41 and the IR laser 61, respectively, to the viewing area of the tissue sample. The UV laser beam 42 and the IR laser beam 62 melt or soften the cap surface, which adheres exposed portions (i.e., the target cells) of the tissue sample to the cap 24, thereby enabling the capture the selected portions (i.e., the target cells) of the tissue sample onto the cap 24. The cap 24 (with the target cells attached or adhered to the cap 24) is then manually removed from the tissue sample, which lifts off or removes the target cells from the remainder of the tissue sample. The microdissected material on the cap is then inspected for positive identification of the captured material and subsequent downstream analysis.

The cap 24 (with the target cells attached) can subsequently be fit onto a Eppendorf tube (such as a 0.5 millileter (mL) Eppendorf tube), which can then be used with a Reagents Kit for downstream applications (e.g., extraction of DNA or RNA for downstream molecular analysis such as gene expression or DNA sequencing).

### Computer System

The microscopy apparatus 30 may further comprise various user input and control devices, such as a computer system including a computer, software, and a display (such as a touch-sensitive screen interface (e.g., a wireless tablet)). All of the components of the microscopy apparatus 30 may be fully integrated with the software of the computer system. The microscope 32, the UV laser assembly 40, and the IR laser assembly 60 may connect to and be controlled by the computer system.

The computer system may allow the user to control the LCM system. For example, through the computer system, the user can take a photo or image from the microscope 32 with the camera 35 (using, for example, Spinnaker Software Development Kit (SDK) for a FLIR camera).

The user may also use the computer system to simply select (via, for example, free hand or with simple shapes, such as a rectangle or circle) the target cells on the tissue sample through a still image or in real-time. The computer system allows the user to place single IR spots that correspond to the laser diameter on the target cell(s) and incorporates a measuring tool to measure the area captured and the diameter of the lasers. The computer system also allows the user to choose which cutting option for the microscopy apparatus 30 to perform on the selected target cells. In particular, through the computer system, the user can instruct the microscopy apparatus 30 to perform an IR LCM, a UV cutting, and/or a UV LCM.

The computer system allows the size of the UV laser beam 42 to be manually assessed and allows both the IR laser beam 62 and the UV laser beam 42 to be located, manually or automatically.

Once the user has manually set up the slide 26, positioned the cap 24, and calibrated the lasers beams 42, 62 to be directed to the slide 26, the user can use the software to select what type of slide 26 (e.g., glass, glass membrane, or metal membrane) has been loaded onto the microscopy apparatus 30.

The user can also use the computer system control both the UV and IR laser assemblies 40, 60 via a USB Relay Controller. The UV and IR laser assemblies 40, 60 may use certain switches of the controller. For example, the IR laser assembly 60 may use switches 1-7 of the controller, and the UV laser assembly 40 may only use switch 8 as an on/off switch. The computer system may also control the power levels and duration of the IR laser beam 62 with single power operations. The computer system may move the stage 34, fire the IR laser beam 62 to facilitate adhesion of the target cells to the cap 24, and fire the UV laser beam 42 to cut along the selected outline of the tissue sample. In particular, the adhesion of the target cells to the cap may be accomplished by patterning the caps with a micro-patterned surface which utilizes Van der Waals forces to serve as gecko-like feet that readily grip the tissue topography of the target cells.

### LCM System Specifications

The precision of the LCM system 20 is the amount of material (i.e., target cells) actually captured versus the area outlined for capture and can be correlated to the resolution of the laser spot size. To provide precise results, the LCM system 20 captures the target cells with 1 μm of precision of which target cells were initially selected compared to where the lasers were actually fired. According to one embodiment, the diameter of the laser spot size of the IR laser beam 62 is approximately 5 μm, and the diameter of the laser spot size of the UV laser beam 42 is approximately 1 μm or less. Furthermore, the stage 34 of the microscope 32 has greater than approximately 1 μm accuracy to ensure the correct target cells are captured. The precision of the LCM system 20 is measured via image analysis with tools such as ImageJ or a ruler measuring and is greater than approximately 95% capture of the target cells within the capture boundaries, as determined by ImageJ analysis.

The reliability of the LCM system 20 is how consistently a given amount of target cells are extracted from a given tissue sample type using a given microdissection setting and extraction area. The reliability also refers to the ability of the lasers to fire in the correct position as selected by the user. The reliability of the LCM system 20 can be measured using a standard tissue sample type, such as a fixed monolayer culture cells or a block of fixed cultured cells, to reduce the effects of inter-patient sample variability on reliability measurements and to standardize measurements using this tissue. When extracting this standard tissue sample type at a given setting with a given extraction area, the quantity of captured material does not vary by greater than approximately 5%.

The sensitivity of the LCM system 20 is the quantifiable amount of DNA, RNA, or protein from a given amount of microdissected tissue. Sensitivity can be measured by quantifying the total amount of extracted DNA, RNA, or protein content from a given number of extracted cells and performing a total protein content analysis using a Bradford assay. The total extracted protein from multiple tissue types of at least 1000 cells will be greater than a predetermined cutoff-value.

The tissue total yield per region of the LCM system 20 is more than approximately 30% better yield of tissue captures per spot compared to IR LCM by Thermo Fischer and approximately equal to UV cutting by Leica, Zeiss, and Thermo Fischer.

### Exemplary Specifications

Table 1 provides exemplary specifications of various values that may be used within the LCM system 20, according to various embodiments.

TABLE 1

| | Approximate | |
|---|---|---|
| Requirement Description | Exemplary Value | |
| UV Laser Nominal Wavelength | 355 | nm |
| IR Laser Nominal Wavelength | 808 | nm |
| Maximum IR Laser cutting speed | up to 250 mm/sec available | |
| Minimum IR Laser cutting speed | ~1 micron per second | |
| Maximum UV Laser cutting speed | up to 250 mm/sec available | |
| Minimum UV Laser cutting speed | ~1 micron per second | |
| Stage position repeatability | 250 | nm |
| Maximum UV laser spot size | Expected <5 μm | |
| Maximum IR laser spot size | Expected <5 μm | |
| UV laser power | >10 | mW |
| IR laser power | up to 250 mW | |
| UV laser pulse frequency | 19,000 | hZ |
| Maximum UV laser pulse duration | 600 | ps |
| permitted | | |
| Minimum still microscope camera | 2448 × 2048 | |
| resolution | | |
| Minimum live microscope camera | 2448 × 2048 @75 fps | |
| resolution | | |
| Range of microscope objective zoom | 2x, 10x, 40x | |
| Overall system maximum height | 72 | cm |
| Overall system maximum depth | 70 | cm |
| Overall system maximum width | 45 | cm |
| Maximum system weight | 55 | kg |
| Wall power voltage | 100-240 | V |
| Wall power frequency | 50-60 | Hz |
| Minimum ambient operating temperature | 15° | C. |
| Maximum ambient operating temperature | 35° | C. |

| | |
|---|---|
| Minimum ambient humidity ratio | 0% |
| Maximum ambient humidity ratio | 60% |

Table 2 also provides exemplary specifications of various values that may be used within the LCM system 20, according to various embodiments.

TABLE 2

| Feature | Details |
|---|---|
| Microscope 32 | Olympus ix73 microscope base |
| | Standard microscope operation outside of LCM |
| | operating software |
| Laser Assemblies | Infrared (IR) Capture Laser: Solid-state, |
| 40, 60 | near-IR (808 nm) with adjustable power output |
| | UV Laser: Solid-state, diode-pumped passively |
| | Q-switched (355 nm) with 20 kHz sub-nanosecond |
| | pulse rate |
| Illumination | High-intensity Halogen illumination system 100 W |
| | transmitted light pillar for ix73 U-LH100IR-1-7; |
| | 12 V/100 W Halogen Lamphouse |
| | Olympus Diascopic Illumination Tower for contrast |
| | imaging (100 W halogen lamp) Long WD DIC/Phase |
| | Condenser, NA 0.55, WD 27MM |
| Objectives 37 | 2x, 10x, and 40x Olympus PLAPON; PLAN APO |
| | objectives |
| | 4x, 20x, 60x, and 100x dry |
| Epi-fluorescence | 2,000-hour broad-spectrum metal halide lamp; |
| | user-replaceable with no alignment required. |
| | Six-position fluorescence filter turret with |
| | three filter cubes (R, G, B) and three available |
| | positions for application-specific filter cubes. |
| Stage 34 | Motorized, joystick- or software-actuated in X |
| | and Y axes with 0.25 m homing accuracy and 0.25 m |
| | bidirectional reproducibility for autonomous |
| | microdissection. “Click and walk.” |
| Contrast Methods | Bright field |
| | Phase contrast (PhL, Ph1, Ph2) |
| | Differential interference contrast (DIC) |
| Microdissection | Color CMOS camera with large Field of View and |
| camera 35 | high resolution (5 MP), low noise, frame rate |
| | of 75 fps at the full 5 MP resolution |

Table 3 provides exemplary parts (and their respective model and brand) that may be used within the LCM system 20, according to various embodiments. As shown, the exemplary parts may be included to perform various functions within the LCM system 20.

TABLE 3

| Function | Part | Model | Brand |
|---|---|---|---|
| UV Beam Expansion | ½″ Plano-Concave UV Coated | LC4924-UV | Thorlabs |
| | lens, −20 mm focal length | | |
| UV Beam Expansion | 8 mm Plano-Concave UV Coated | LC4291-UV | Thorlabs |
| | lens, −12 mm focal length | | |
| UV Beam Expansion | 8 mm to ½″ lens adapter | LMRA8 | Thorlabs |
| UV Beam Expansion | 1″ Plano-convex UV coated lens, | LA4924-UV | Thorlabs |
| | 175 mm focal length | | |
| UV Beam Expansion | 1″ Plano-convex UV coated lens, | LA4102-UV | Thorlabs |
| | 200 mm focal length | | |
| UV Beam Expansion | 1″ Plano-convex UV coated lens, | LA4579-UV | Thorlabs |
| | 300 mm focal length | | |
| IR Beam Expansion | 2x IR Beam Expander | GBE02-B | Thorlabs |
| Beam Optics Train | 0.5″ long 1″ diameter tube | SM1L05-P5 | Thorlabs |
| Beam Optics Train | Kinematic cage mirror mount | KCB1 | Thorlabs |
| Beam Optics Train | IR passthru, UV reflective mirror | Y3-1025-45 | CVI Laser |
| | | | Optics |
| Beam Optics Train | 0.5″ iris | SM05D5 | Thorlabs |
| Beam Optics Train | 0.5″ diameter lens tube | SM05L20C | Thorlabs |
| Beam Optics Train | SM05 to SM1 adapter type 1 | SM1A1 | Thorlabs |
| Beam Optics Train | SM05 to SM1 adapter type 2 | SM1A6 | Thorlabs |
| Beam Optics Train | 4″ SM1 Tube | SM1L40 | Thorlabs |
| Beam Optics Train | Zoom lens housing for ½″ | SM1NR05 | Thorlabs |
| | optics | | |
| Beam Optics Train | 1″ iris | SM1D12 | Thorlabs |
| Beam Optics Train | 1″ diameter lens tube | SM1L30C | Thorlabs |
| Beam Optics Train | Lens tube coupler | SM1T1 | Thorlabs |
| Beam Optics Train | Lens tube coupler | SM2T2 | Thorlabs |
| Beam Optics Train | High-precision SM1 compatible | SM1ZM | Thorlabs |
| | zoom mount | | |
| Beam Optics Train | RMS to SM1 Adapter | SM1A3 | Thorlabs |
| Beam Optics Train | SM1 tube mount | SM1RC | Thorlabs |
| Mounting Hardware | ¼-20 half-inch long cap screws | SH25S050 | Thorlabs |
| Mounting Hardware | 8-32 capscrews, quarter inch | SH8S025 | Thorlabs |
| | long | | |
| Lighting | RL2 Ring Light | RL2-50 PW | Starlight Opto |
| | | | Electronics |
| Lighting | RL2 Diffuser | 100-010994 | Starlight Opto |
| | | | Electronics |
| Lighting | 220 grit mounted diffuser, 2″ | DG20-220-MD | Thorlabs |
| | diameter | | |
| Lighting | Dual gooseneck light | LED-6W | Amscope |
| Mounting Hardware | Translating post holder | PH3T | Thorlabs |
| UV Laser Electronics | Female utility connector | 1195-1737-ND | Digikey |
| Beam Optics Train | Infinite Conjugate, DUV Coated, | Stock #89-722 | Edmund Optics |
| | 10X/0.23NA ReflX Objective | | |
| Mounting Hardware | SM2 tube mount | SM2TC | Thorlabs |
| Tools | SM2 Spanner Wrench | SPW604 | Thorlabs |
| Tools | SM1 Spanner Wrench | SPW602 | Thorlabs |

As utilized herein, the terms “approximately,” “about,” “substantially” and similar terms are intended to have a broad meaning in harmony with the common and accepted usage by those of ordinary skill in the art to which the subject matter of this disclosure pertains and should be interpreted as including at least a de minimis level of variance from the identified value. It should be understood by those of skill in the art who review this disclosure that these terms are intended to allow a description of certain features described without restricting the scope of these features to the precise numerical ranges provided. Accordingly, these terms should be interpreted as indicating that insubstantial or inconsequential modifications or alterations of the subject matter described and are considered to be within the scope of the disclosure.

The terms “coupled,” “connected,” “attached,” and the like as used herein mean the joining of two members directly to one another. Such joining may be stationary (e.g., permanent) or moveable (e.g., removable or releasable).

References herein to the positions of elements (e.g., “top,” “bottom,” “above,” “below,” etc.) are merely used to describe the orientation of various elements in the FIGURES. It should be noted that the orientation of various elements may differ according to other exemplary embodiments, and that such variations are intended to be encompassed by the present disclosure.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. For example, the position of elements may be reversed or otherwise varied, and the nature or number of discrete elements or positions may be altered or varied. The order or sequence of any process or method steps may be varied or re-sequenced according to alternative embodiments. Other substitutions, modifications, changes and omissions may also be made in the design, operating conditions and arrangement of the various exemplary embodiments without departing from the scope of the present invention.

What is claimed is:

1. A microscopy apparatus comprising:
a microscope comprising a stage configured to hold a tissue sample;
a UV laser assembly configured to emit a UV laser beam to a viewing area of the tissue sample; and
an IR laser assembly configured to emit an IR laser beam to the viewing area of the tissue sample, the UV and IR laser assemblies being oriented so as to emit the respective UV and IR laser beams in a same direction.

2. The microscopy apparatus of claim 1, wherein the UV laser assembly comprises a UV mirror configured to change a direction of the UV laser beam.

3. The microscopy apparatus of claim 2, wherein the IR laser assembly comprises an IR mirror configured to change a direction of the IR laser beam.

4. The microscopy apparatus of claim 3, wherein the UV mirror is positioned along an optical axis of the microscope.

5. The microscopy apparatus of claim 4, wherein the IR mirror is positioned along the optical axis of the microscope and is in series with the UV mirror.

6. The microscopy apparatus of claim 5, wherein the IR mirror is positioned directly above the UV mirror along the optical axis of the microscope.

7. The microscopy apparatus of claim 3, wherein the UV mirror is positioned outside of an optical axis of the microscope.

8. The microscopy apparatus of claim 3, wherein the microscope comprises a light source configured to direct light to the viewing area of the tissue sample, wherein the light source is positioned above the IR mirror along the optical axis.

9. The microscopy apparatus of claim 2, wherein the microscope comprises an objective lens and a light source that are positioned above the stage, wherein the light source is configured to direct light to the viewing area of the tissue sample and is positioned outside of an optical axis of the microscope.

10. The microscopy apparatus of claim 9, wherein the light source is positioned vertically below the IR mirror.

11. The microscopy apparatus of claim 1, wherein the UV laser beam and the IR laser beam are configured to contact the viewing area of the tissue sample at an approximately normal angle.

12. The microscopy apparatus of claim 1, wherein the UV laser beam is configured to contact the viewing area of the tissue sample at an oblique angle, and the IR laser beam is configured to contact the viewing area of the tissue sample at an approximately normal angle.

13. A laser capture microdissection system comprising:
a cap configured to adhere to target cells from a tissue sample when exposed to UV light and IR light; and
a microscopy apparatus comprising
a microscope comprising a stage configured to hold the tissue sample and the cap,
a UV laser assembly configured to emit a UV laser beam to a viewing area of the tissue sample, and
an IR laser assembly configured to emit an IR laser beam to the viewing area of the tissue sample, the UV and IR laser assemblies being oriented so as to emit the respective UV and IR laser beams in a same direction.

14. The laser capture microdissection system of claim 13, wherein the UV laser assembly comprises a UV mirror configured to change a direction of the UV laser beam.

15. The laser capture microdissection system of claim 14, wherein the IR laser assembly comprises an IR mirror configured to change a direction of the IR laser beam.

16. A method of removing target cells from a tissue sample, the method comprising:
loading a tissue sample onto a stage of a microscope;
selecting the target cells to be removed from the tissue sample;
placing a cap on the tissue sample, wherein the cap is configured to adhere to the target cells from the tissue sample when exposed to both the UV light and IR light;
emitting a UV laser beam from a UV laser assembly to a viewing area of the tissue sample;
emitting an IR laser beam from an IR laser assembly to the viewing area of the tissue sample; and
removing the cap with the target cells adhered to the cap from a remainder of the tissue sample.

17. The method of claim 16, further comprising changing a direction of the UV laser beam with a UV mirror of the UV laser assembly.

18. The method of claim 17, further comprising changing a direction of the IR laser beam with an IR mirror of the IR laser assembly.
